(19) United States
(12) Patent Application Publication
(10) Pub. No.: US 2006/0235713 A1
(43) Pub. Date: Oct. 19, 2006

(54) TOOLS AND TECHNIQUES FOR REDIRECTED EXPENDITURES FUNDRAISING

(76) Inventors: Brian D. Tobler, Syracuse, UT (US); Chad B. Reid, South Ogden, UT (US); Chad L. Fox, North Salt Lake, UT (US)

Correspondence Address: OGILVIE LAW FIRM, 1320 EAST LAIRD AVENUE, SALT LAKE CITY, UT, 84105, US

(21) Appl. No.: 11/279,938

(22) Filed: Apr. 17, 2006

Related U.S. Application Data
(60) Provisional application No. 60/672,354, filed on Apr. 18, 2005.

(51) Int. Cl. G06Q 99/00

(52) U.S. Cl. 705/1

(57) ABSTRACT

In a charitable donation arrangement (300), individual members (302) select (702) a service provider (308) using one interface (202), select (704) a charity (304) using another interface (204), and specify how funds from their payments (214) of recurring bills from the service provider should be redirected (328, 334) to the charity. A personalized member portal (100) in a facilitator website (200) also provides the member in question with a detailed accounting (212) showing the total payments (214) made by the member to the service provider for the subscribed service (338), shows the pool (216) of funds available to be redirected from such payments according to instructions from the member, and shows the amounts (218) of redirected funds already donated to charity instead of being retained or obtained by the service provider as part of the monthly service payment.

### RELATED APPLICATION

The present application claims priority to, and incorporates by reference, U.S. provisional patent application Ser. No. 60/672,354 filed Apr. 18, 2005.

### FIELD OF THE INVENTION

The present invention relates generally to fundraising and management of charitable donations, and in particular relates to donations that are redirected to charity from payments of recurring service provider charges.

### BACKGROUND OF THE INVENTION

Marketing alliances between affiliates and large service providers is generally a known concept. For instance, large telecommunication service providers have initiated promotions to sell their services to their affiliate members and in exchange, to provide a donation to the affiliate for any sales derived. Indeed, such marketing is sometimes called Affiliate Marketing. In this background context, the term “affiliate” is used generally, as opposed to its specific uses below in connection with embodiments of the present invention.

Such marketing has not been particularly successful, for several reasons. First, affiliate members tend to perceive the marketing as a ploy by the service providers to make more money for themselves and not support or care about the cause and thus, affiliate members refuse to participate. Second, the resources required for an affiliate to manage and promote the marketing internally is insufficient and thus, grass-roots support of the campaign is small or non-existent. Third, affiliations and service providers need to make sure that they support each others' goals and have synergistic reasons for combining forces. A service provider whose customers' opinions cover a broad spectrum may not want to alienate some of those customers by prominently affiliating with a cause that is controversial, and hence likely to be at odds with the strongly held opinions of at least some customers, even if other customers would applaud such an affiliation.

Other aspects of culture or technology, which are discussed herein, discussed in documents submitted with this application, or previously known to those of skill in the art, may also be helpful in understanding the present invention.

### BRIEF SUMMARY OF THE INVENTION

The invention provides tools and techniques for improving customer loyalty to service providers, and for helping donors with gift-giving in a charitable donation arrangement. Some embodiments include an interactive member portal accessible by an alliance member to manage a charitable donation arrangement through a computer network. The member portal includes an accounting showing at least one donation amount, a browser or other programmed interface for selecting at least one service provider from multiple identified service providers and an identification of at least one selected service provider, a browser or other programmed interface for selecting at least one charity from multiple identified charities and an identification of at least one selected charity. The at least one donation amount shows at least one amount which is redirected to the at least one charity from each of a sequence of payments of monthly or otherwise recurring bills for at least one service which the at least one service provider provides to the alliance member. Example services may be internet related, telephone services, media or entertainment services, utility services, goods financing services, and/or other subscription-type services, that is, services for which billing is not one-time but is instead recurring.

In some embodiments, a method of interactive control of a charitable donation arrangement is provided through the internet or another computer network. The method includes providing over the network a programmed interface for selecting at least one service provider from multiple identified service providers, providing over the network a programmed interface for selecting at least one charity from multiple identified charities, and providing over the network a description of the charitable donation arrangement which indicates that under the arrangement a donation amount will be redirected to at least one charity selected by an alliance member from each of a sequence of payments of a recurring bill sent to the alliance member from at least one service provider selected by the alliance member. The interfaces may be equivalently viewed as two parts of a single larger interface in some implementations. Each of the providing steps occurs at least at an alliance member location, namely, a location which presents the interfaces to the alliance member. Thus, a server generating data for the interface may be located in one country, while the providing steps occur in another country where the alliance member using the interface is located.

As noted, methods may be used by alliance members to authorize donations to charities. Similarly, some methods are used by charities, some by facilitators who provide member portals, and some by service providers. One method is for use by a service provider to promote customer loyalty by providing a member service in a charitable donation arrangement. This method includes the service provider agreeing to be one of multiple service providers that are identified to an alliance member as service providers who will donate to at least one charity a portion of each of a sequence of payments of a recurring bill for a service to be provided to the alliance member as a customer of the service provider. The sequence is not necessarily each consecutive payment. The service provider provides the service to the alliance member, bills the alliance member on a recurring basis for payment for the service, and authorizes payment on a recurring basis (that is, from at least some of the service fee payments) of a donation amount to the at least one charity, as agreed. The service provider may directly or indirectly provide the alliance member with an accounting showing information such as the donation amount per billing cycle and a total donation amount made up to a specified date, for the individual alliance member as a service provider customer.

Although many of the examples given herein are methods and some are portals (a type of interface on a network), the invention provides generally corresponding devices, systems, configured computer-readable storage media, signals, and process products, as well as methods and portals. The examples given are merely illustrative. The present invention is defined by the claims, and to the extent this summary and/or incorporated material from a parent priority document conflicts with the claims, the claims should prevail.

### BRIEF DESCRIPTION OF THE DRAWINGS

To illustrate the manner in which the advantages and features of the invention are obtained, a description of the present invention is given with reference to the attached drawing figures. These drawings only illustrate selected aspects of the invention and thus do not fully determine the invention's scope.

FIG. 1 shows a screenshot of a portal from an existing website portal according to the present invention.

FIG. 2 is a block diagram further illustrating websites, portals, and other interfaces according to the present invention.

FIG. 3 is a block diagram illustrating a facilitator website, an alliance member, a charity, a service provider, other roles, and various interactions and data flows, in a configuration employing an embodiment of the present invention.

FIG. 4 is another block diagram illustrating roles and interactions in a configuration employing an embodiment of the present invention.

FIG. 5 is another block diagram illustrating portals, devices, and a network according to the present invention.

FIG. 6 is another block diagram illustrating some websites according to the present invention.

FIG. 7 is a flowchart illustrating methods of the present invention, mainly from the perspective of a facilitator in a charitable donation arrangement.

FIG. 8 is a flowchart illustrating methods of the present invention, mainly from the perspective of a service provider in a charitable donation arrangement.

### DETAILED DESCRIPTION OF THE PREFERRED EMBODIMENTS

The present invention provides tools and techniques which may help facilitate, manage, and promote charitable donation arrangements in which (for instance) part of a monthly service provider payment is redirected to charities selected by the person who receives the services and makes the monthly payments. The invention is illustrated in text and drawings by specific examples, but it will be appreciated that other embodiments of the invention may depart from these examples. For instance, specific features of an example may be omitted, renamed, grouped differently, repeated, instantiated in hardware and/or software differently, performed in a different order, or be a mix of features appearing in two or more of the examples.

Definitions of terms are provided explicitly and implicitly throughout this document. Terms do not necessarily have the same meaning here that they have in the Background above, in general usage, in the usage of a particular industry, or in a particular dictionary or set of dictionaries. Reference numerals may be used with various phrasings in the text and figures, to help illustrate the breadth of referenced items. The inventors assert and exercise their right to their own lexicography.

As a particular example, the term “charity” and related terms are used broadly herein to include not only tax-exempt charitable organizations but also other organizations which represent causes. Thus, charities include educational institutions and politically active organizations, for example, as well as organizations devoted to disaster relief, poverty mitigation, and other reductions in suffering.

Overview

The present invention combines a target group's willingness to give with their willingness to pay for such things as internet access, wireless cell phone service, telephone service, VOIP service, cable/satellite TV service, and other services, and for goods obtained with a financing service. Some embodiments include creating or using an alliance that establishes a marketing convergence between service providers looking for new opportunities to market their services, and organizations and associations (affiliations) looking for fund-raising opportunities. The embodiments fill a gap by providing solutions that can create successful relationships for members of the alliance. At the same time, when viewed as a business model, such embodiments place a high priority on supporting and managing the relationship with the member affiliation; participants reflect care for the affiliation's cause, and business is built around the commitments of each affiliation and its members to the cause as well as other goals.

In one embodiment, a strategic working agreement is made with service providers, under which a marketing campaign sourced directly from the affiliate's executive team will target the affiliate's membership to support the alliance. At no extra cost and for the same quality service, members would sign up for the services through the alliance. Once the service commences, the service providers would donate a small portion of the recurring bill to the alliance. Prior to forwarding funds to each affiliate, a management fee (e.g., 30% or another agreed-on percentage of gross revenue, or a fixed amount) from service providers will be charged by a facilitator to manage the relationship. The remaining balance will be passed on to the affiliation as a monthly, residual donation for as long as the new subscriber stays with the service provider.

In some embodiments, a membership portal is provided or used. The portal may be a custom built, web-based portal that will be created for members of the alliance. Subscribers (affiliate members) will be able to access key information regarding their account, make changes to the account, sign-up for service, cancel service, and manage the funds that are accumulated from the services they initiated through the alliance. This portal may be found within the facilitator's website and can give subscribers the ability to direct funds distribution on a monthly basis, or on another periodic or otherwise recurring basis.

In some embodiments, the portal allows password-protected user access to information regarding account information, account alterations, service subscriptions, cancellations, customer service and auditing/reporting functions. Subscriber members may also have a forum where they can access their personal account, review funds in the account and directly distribute those funds to the association of their choice. The web-based portal may reside within the facilitator's corporate website. Access to data may also be provided via telephone and fax services that will originate from the facilitator's corporate headquarters.

In some embodiments, a portion of service provider fees paid by the member are redirected to a member-specific charitable pool, which the member can then distribute between one or more charitable organizations. The member may allocate all of the pool to the charitable organization that is the alliance participant that marketed the alliance to the member, or the member may distribute the pool differently.

In some embodiments, product/service offerings 612 from the alliance to affiliate members include one or more of the following, on a local, regional, national, and/or international basis: dial-up internet services, DSL and/or broadband internet services (residential or business), VOIP and DSL combined service (residential or business), web hosting and/or related services, web site production services, wireless cell-phone services, cable/satellite TV services, online purchases, other miscellaneous services.

Portals and Websites

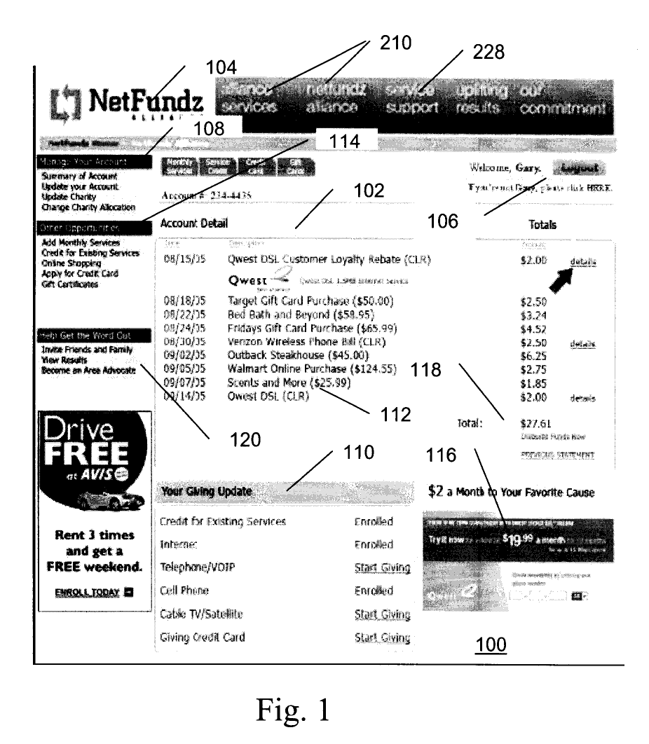

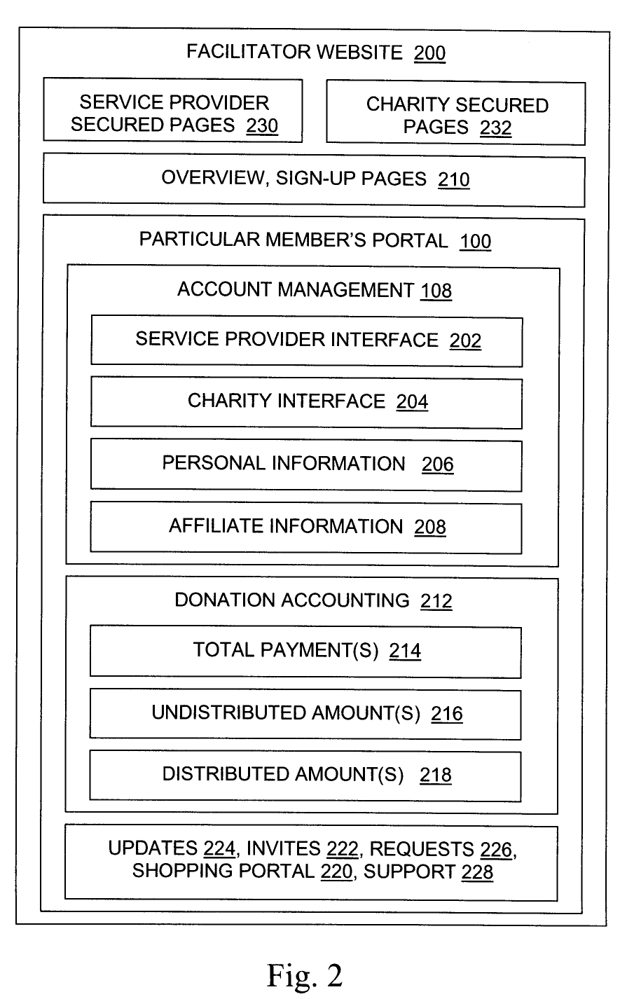

In some embodiments, a customized web portal allows members to track affiliation payments and ultimately control where they would like the redirected funds to be donated. With particular reference to FIGS. 1 through 5, for instance, members 302 of an alliance 300, 400 may use a web portal 100 provided 710 by a facilitator 310 to state 716 a distribution 102 according to which the specified portion of funds received (directly or indirectly) from the member should be distributed among the one or more charities 304.

FIG. 1 illustrates portal components in a screenshot from promotional material of NetFundz LLC, owner of the present invention. A publicly available commercial facilitator website 200 embodying at least some aspects of the present invention went live at www dot netfundz dot com after filing of the above-identified provisional application and prior to the filing of applications claiming priority to the provisional. FIG. 1 illustrates aspects of the invention embodied in that public website. NetFundz operated as a facilitator 310 to provide administrative services and other support for charitable donation arrangements.

A link 104 (e.g., an HTTP hyperlink) to a home page 602 is provided. In the screenshot of FIG. 1, this link is associated with a graphic logo which is a mark of NetFundz Alliance. A member identification area 106 identifies the member 302, and links to a login/logout page 604. In FIG. 1, this area identifies and welcomes the member using the member's first name, and has a button link to Logout. Personal member information 206 may include the member's name, the name of zero or more affiliates 306 to which the member belongs, and contact information such as an email address provided 716 by the member. Affiliates may also be listed elsewhere 208.

Member account management page(s) 100, 108 provide 702, 204, 710, 716 an interface for obtaining from the member, displaying to the member, and allowing the member to edit, various types of information 202, 204, 206, 208. In FIG. 1, the account management section 108 has a heading “Manage Your Account” under which are listed the following links: Summary of Account, Update Your Account, Update Charity, Change Charity Allocation. The latter two links are part of a charity interface 204 for selecting 704 charities to receive redirected funds.

Service provider information 202 provides 702 information identifying available service providers 308 who have agreed 802 to participate in a charitable donation arrangement such as arrangement 300, arrangement 400, or another arrangement according to the present invention. Service provider information 202 also tells the member which service providers, if any, have been selected 702, 716 by the member for funds redirection under the charitable donation arrangement. As illustrated by listings 110, 112, service providers may be listed in a portal interface 202 by name and/or by the type of service they provide. Links, dialog boxes, pull-down lists, pop-up lists, defaults, applets, and other GUI tools and techniques may be used in a portion 114, 606, 608, 610 of the service provider interface 202 that allows the member to select (and de-select) particular service providers.

In FIG. 1, listing 110 has a heading “Your Giving Update” under which is listed the following: Credit for Existing Services—Enrolled, Internet—Enrolled, Telephone/VOIP—Start Giving (this is a link), Cell Phone—Enrolled, Cable TV/Satellite—Start Giving (link), Giving Credit Card—Start Giving (link). The “Start Giving” link takes the member to the portion of the service provider interface 202 and/or charity interface 204 that allows the member to authorize redirection of service provider payment(s) in part to one or more charities 304. This page 210 may also allow the member to sign up 716 with service providers 308 as a new customer, under the charitable donation arrangement, if the member is not already a customer of those service providers. Service sign-up pages may also be reached through advertising 116 in the member portal 100 or elsewhere on the facilitator website 200.

In FIG. 1, the accounting 112 includes a list of service providers the member is already subscribing to, together with redirected fund donation amounts and dates. A total donation 118 for a given time period, specific to this member, is also shown. More generally, a donation accounting 212 may list 708 information such as the total payment amount 214 billed 806 to the member by the service provider, the amount of redirected funds 216 from the bill payment that is available to be donated, and the amount of redirected funds 218 that have been donated. This information is specific to the member in question, so the member can see 716 on screen what his or her own personal donation effect has been, and what it can be. The accounting 212 may list funds received from the member 302 in question and/or funds due. It may list the member's total payment to each service provider 308, the amount 216 of that payment that has not yet been redirected to any of the charities 304, and the amount 218 that has been redirected to each of one or more charities 304 per the member's instructions through the portal 100. If the member belongs to more than one affiliate 306, then funds may also be tallied 502 according to affiliate. More generally, an aggregate accounting 502 may also be given 708, separately or as part of the accounting 212, showing the total funds redirected via the alliance for one or more groups of people. For instance, the aggregate accounting may show the total amount redirected to a particular charity by all members of a particular affiliate.

In FIG. 1, an area 114 has a heading “Other Opportunities” under which is listed the following links: Add Monthly Services, Credit for Existing Services, Online Shopping, Apply for Credit Card, Gift Certificates. The first two are links to a portion of the service provider interface 202 that allows the member to select 702, 716 service providers for charitable donation through recurring payment funds redirection, as discussed herein. The Online Shopping link leads to an online shopping portal 220 through which the member can access websites 322 of merchants that will make a charitable donation to charities specified by the member, when the member makes an online purchase from them. The Apply for Credit Card link allows the member to apply for a credit card, in an arrangement that donates some portion of the transaction amount to charity when the credit card is used by the member. Gift Certificates obtained through the portal 100 may similarly result in a charitable donation when purchased, or when redeemed.

FIG. 1 also shows an area 120 with a heading “Help Get the Word Out” under which are listed the following links: Invite Friends and Family, View Results, Become an Area Advocate. The first link is an example of mechanisms 222 by which an alliance member can invite 312 other people 314 to become alliance members. This may be done, for instance, by obtaining 716 the candidate's email address from the member and then automatically sending the candidate 314 an invitation email identifying the member, with a link to descriptive pages 210 that explain the alliance goals and processes and offer the candidate an alliance registration page 210.

More generally, facilitator websites may contain hyperlinks, contact information, and/or other links to one or more of the following: FAQs 210 explaining operation of the alliance, as discussed generally above for example; registration information and pages 210 to allow members to register for participation in the alliance based on their membership in an affiliate; legal information such as notices and agreements; and other administrative information. Websites 200 may also contain news and links 224 provided by charities in which the member has shown interest; links or other mechanisms 226 allowing the member to request 316 participation of another charity 318 and/or another service provider 320 when that entity is not yet part of the charitable donation arrangement; and/or links, email, or other mechanisms 228 requesting support as a service provider's customer. Links 224 to charitable organizations may include their contact information and/or hyperlinks to their web sites. Links 224 to particular charitable activities may also be provided, for letter-writing campaigns, disaster relief efforts, and the like.

Some embodiments of the facilitator website 200 include service provider secured pages 230, through which the facilitator and the service provider can confidentially communicate 716. Such communications might include, for instance, the terms and conditions on which the facilitator provides paid 814 marketing and/or administrative services to the service provider, aggregate information about members who subscribe to services under the charitable donation arrangement through the website 200, bank account and other financial information for authorizing 810 or auditing the donations, pages providing 812 member payment and other financial and/or identifying information for processing into the accounting 212 reported to the member, and/or billing and payment history for the fees charged 814 to the service provider by the facilitator. Pages 230 containing such information are secured 712 through password protection, digital signatures, encryption, secure networking protocols, and/or other familiar information security tools and techniques.

Some embodiments of the facilitator website 200 include charity secured pages 232, through which the facilitator and the charity can confidentially communicate 716. Such communications might include, for instance, the terms and conditions on which the facilitator provides marketing and/or administrative services to the charity, aggregate information about members who redirect funds for donation to the charity under the charitable donation arrangement through the website 200, and/or bank account and other financial information for auditing the donations. Pages 232 containing such information are secured 712 through familiar information security tools and techniques.

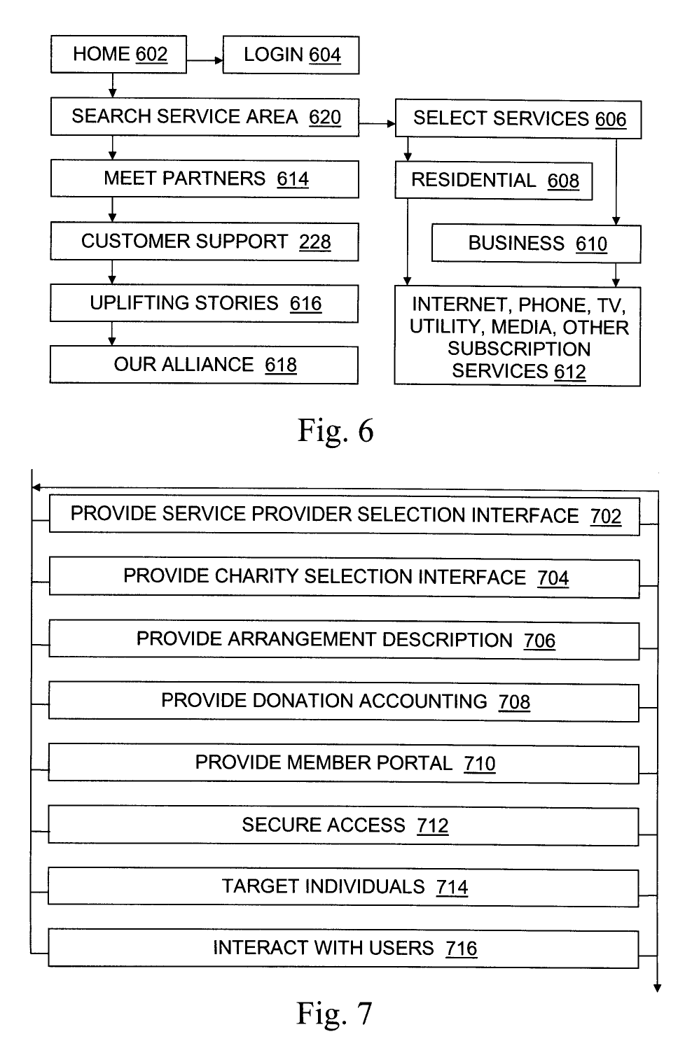

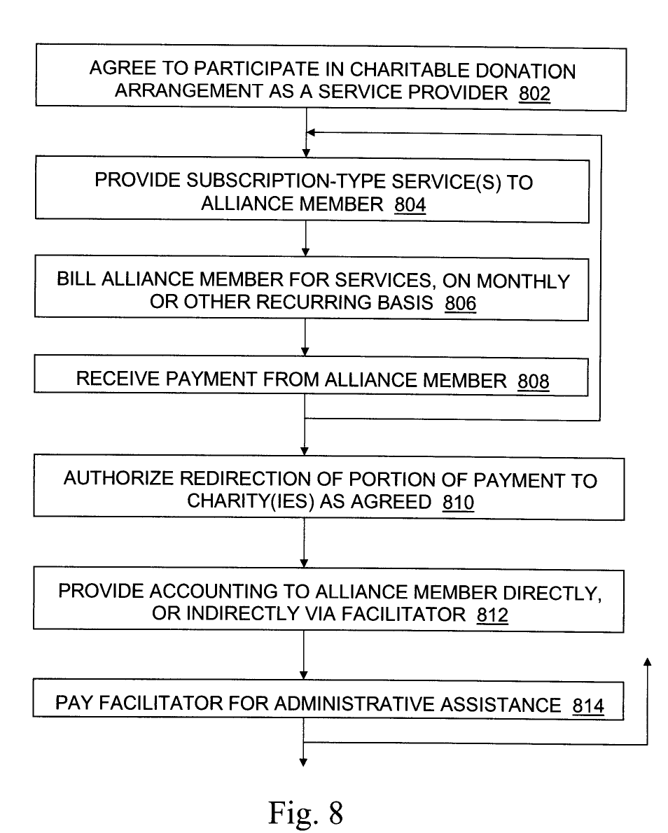

FIG. 6 illustrates additional components of some embodiments of the facilitator website 200. In addition to components already discussed, a “search service area” link or other navigational mechanism 620 takes users to information about services offered by the facilitator and/or by service providers. A “meet partners” description area 614 introduces 706 merchants 308, charities 304, and customers 302 to one another in the context of the alliance 300, 400. An “uplifting stories” area 616 provides examples of good deeds and results made possible by charitable donations. An “our alliance” area 618 gives 706 historical background on the alliance, and discusses its goals, processes, and commitments.

More About Charitable Donation Arrangements

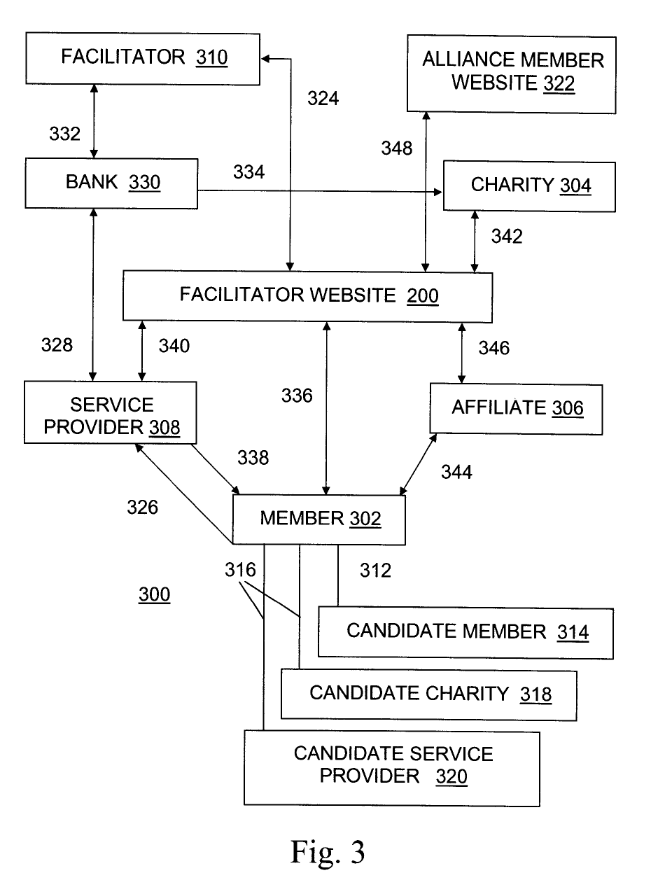

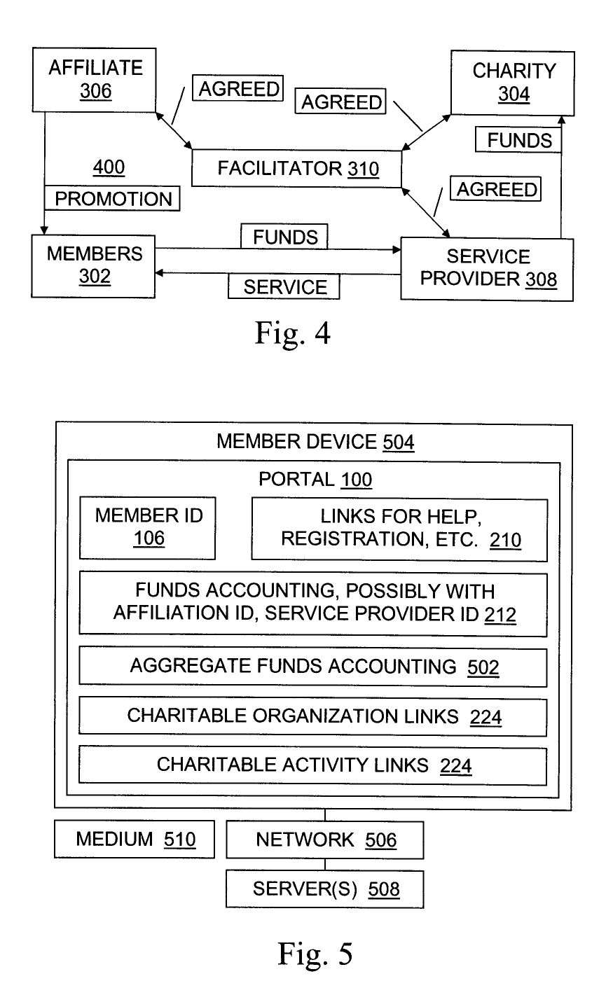

FIGS. 3 and 4 illustrate charitable donation arrangements according to the present invention. Inventive embodiments do not, of course, include charities, service providers, members, or other entities per se. Rather, embodiments are directed toward methods performed by or for such entities, and toward portals, configured media, and other machines used by one or more such entities, for example. Understanding the roles, funds flows, and data flows illustrated in the figures may help one more fully appreciate embodiments of the invention.

A facilitator 310 provides and maintains 324 a website 200, which contains individually tailored portals 100 provided 710 for individual members 302 of an alliance facilitated by the website. Portals may also be provided on the website for service providers and/or charities. Service providers 308 identified on the website 200 can be selected 702 by a member, which results in a portion of that member's monthly or other subscription-type payment 326 to the service provider that is paid 808 by the member 302 being deposited 328 in an escrow or bank 330 account administered 332 in part by the facilitator, which distributes 334 those funds to charities 304 as directed 336 by the member. The member receives 804 services 338 from the service provider in exchange for the payment. In some embodiments, service providers may be those to whom the member subscribes 336 through the website 200, and in some they may be existing service providers, that is, providers with whom the member had a pre-existing relationship outside the alliance 300. Service providers may be able to advertise 340 on the site, track 340 aggregate subscriber data through secure pages 230 of the site 200, and/or otherwise interact 716 with the site. Charities may likewise be able to advertise 342 on the site, track 342 aggregate donation data through secure pages 232 of the site 200, and/or otherwise interact 716 with the site.

Alliance members may also belong 344 to affiliated organizations, which may or may not be charitable organizations. Such affiliates may be able to advertise 346 on the site, track 346 aggregate affiliate member data through secure pages of the site 200, and/or otherwise interact 716 with the site. Members 302 may also be able to access 348 alliance merchant websites 322 through a shopping portal 220 of the facilitator website 200.

An affiliate organization 306 has members 302. Many types of affiliate organizations may benefit from participation in an alliance according to the present invention, such as for example (and without limitation) charitable organizations 304 and others concerned with issues such as poverty, hunger, illness, education, the environment, disabilities, social issues, religious issues, racial issues, gender issues, political issues, and other causes around which people gather. The affiliate enters 802 an agreement with a facilitator 310, under which the affiliate sends direct marketing, and/or otherwise promotes an offering, to the affiliate's members 302. The offering is for members 302 to obtain goods and/or services, from the service providers(s) 308, at the suggested retail price in some embodiments and at a reduced price or with a discount of some type in other embodiments. The facilitator 310 and the service provider(s) 308 have an agreement under which a specified portion (percentage, or flat amount, for instance) of funds received by the service provider from such members 302 will be redirected to charities 304. The charities and the facilitator have an agreement which allows the facilitator to contract with the affiliate to do promotions to the members 302 with the charities' approval, e.g., to use the charities' names in the promotion.

In some embodiments, the facilitator targets 714 consumers who currently have membership in partner affiliations and who utilize or would like to incorporate technology services into their daily lives. Internet access (dial-up or broadband), wireless cell phones, cable/satellite TV, and telephone service, for example, may be among the services 612 targeted. Through a strategic working agreement with these service providers, a marketing campaign sourced directly from the affiliate's executive team will target their membership to support the alliance. At no extra cost and for the same quality service, members would simply sign-up 210 for the services 338 through the alliance. Once service commences, the service providers would donate 328, 334 a small portion of the recurring bill 806 payment 326, 808 back to the affiliate 304 on a monthly (or other recurring) basis for as long as the new consumer 302 stays with the service provider. In some embodiments, when a member 302 purchases a ring-tone, song, video, game, or other item for their cell phone, PDA, or other handheld device, from a participating merchant or service provider 308, a portion of the payment for that item is redirected to a charity 304 selected by the member.

This creates a “win-win” scenario. Consumers (affiliate members) would receive the same price, service and support as normal but would be indirectly assisting the affiliation with their fund-raising efforts. Service providers would be creating a “stickiness” to their marketing campaigns to keep consumers loyal, and could see a direct increase in sales utilizing this marketing tool. Affiliations would generate substantial amounts (depending on the participation of their membership) in fund-raising by asking members to re-direct 810 towards the affiliation a portion of the service fees that they are currently paying 808 directly to service providers.

One characteristic of such a fund-raising effort may be that an alliance merely requires an affiliation to endorse 344 the facilitator as a legitimate partner to its membership. With an executive endorsement, the facilitator then does all or substantially all of the marketing 336, management and follow-through to create a residual stream of revenue that will provide a stream of financial support to the affiliation. Payment of residual revenue will be as a monthly or quarterly donation from the facilitator alliance to the affiliations, or on another agreed schedule.

Under one suitable revenue model, a facilitator 310 is committed to supporting the affiliation 304 and its members in achieving a fund-raising result. Toward that end, the facilitator makes a binding commitment to each of the service providers and affiliations in the alliance that the facilitator's accounting and business practices, management teams and internal auditing practices, for example, abide by a specified code of ethics which goes beyond mere legal requirements.

In exchange for this commitment, and to cover costs associated with the management and operation of the facilitator alliance, the facilitator charges 814 a management and marketing fee. This may be a flat fee, or it may be based on gross revenue generated from service providers before the proceeds are paid as a donation to the affiliations. This percentage may vary between or within an embodiment, but may average 25-35% for instance, depending on the expense and over-head associated with each service offering.

In some embodiments, the facilitator makes 802 agreements with affiliation partners that secure an exclusive working arrangement for a period of time to ensure loyalty and commitment to the alliance. In some embodiments, the facilitator builds long-term relationships with alliance partners. The facilitator is flexible so it can build and manage additional services and/or products that fit alliance partner needs and development criteria.

Under the present invention's approach, service providers don't necessarily have to support the causes involved, because the actual choice of where funds are distributed is given 704 to members of the alliance, e.g., through the portal 100. Members are allowed to distribute funds that have accumulated in their individual pool to the affiliate 304 of their choice. They can also view 708 the donations through reporting features, and in some jurisdictions may use tracking and report functions to create a year-end summary of donations for tax purposes (e.g., deduction receipts).

The facilitator may establish an alliance shopping portal 220 whereby members can choose services normally offered on the internet though the portal. If members sign up 702 for the services through the portal, supporting service providers 308 would make a donation to the member's pool. This opens the number of services and products to represent many different offerings.

Different affiliates may present different information 224 and/or capabilities through the portal. That is, the portal 100 could be tailored to a particular affiliate 304, and/or tailored to a particular type of affiliate, as well as being tailored to a particular member 302. Some embodiments include a web-based home page 602 which some or all members may choose to incorporate. This home page would be developed by the facilitator 310 but be tailored to the affiliates 304 that have been chosen by the member. As members access the internet, this home page would be their portal. Within the portal, areas for affiliates to integrate 346 company news clippings or information, reminders, promotions, convention dates, and so on 224 would be inserted and managed by the facilitator on behalf of the affiliate. The result would be a custom-built web portal for each affiliate that participates.

With respect to service providers, in some embodiments the portal 100 may also be tailored to a particular service provider 308, and/or tailored to a particular type of service provider, as well as to a particular member 302. As another source of income for the alliance, service providers would be enabled to advertise 340 and promote their company on the home page or elsewhere in the web portal, for additional marketing exposure. An advertising fee would be paid 814 by the provider for this.

More About Facilitators

In some embodiments, a facilitator 310 provides philanthropic administrative services for small and large clients 308. Such services may include building and leveraging customizable, online and offline philanthropic marketing 714 campaigns to spur organic growth, increase retention and enhance relationships with each of the affiliate's individual customers. This may be done in part through messages 716 to members 302 along the lines of “You're an important (customer, shareholder, employee) and (client's name) wishes to support the cause your passionate about.”

The facilitator may provide full auditing capabilities to ensure proper payment and distribution of donations. The facilitator services may include administration of all financial trails 328, 332, 334 of donations and general donation distribution in the alliance 300, 400. The facilitator may provide 708, 228, 230, 232 online, offline and call center support for donation solicitations. The facilitator may provide 708, 812 individuals with online account access 212 to track donations, account administration and participate in other opportunities to increase donations through online shopping portals 220 and other programs.

The facilitator may initiate and manage all coordination for communication and marketing campaigns with all partners of the alliance. The facilitator may develop and manage a database 206, 508, 510 of charitable individuals and provide valuable data regarding demographics, ad hoc reporting, distribution of funds, etc. The facilitator may search, screen and validate charitable organizations 304 in compliance with the United States Patriot Act and similar laws in other jurisdictions. The degree and the parameters of the donation participation level may be determined and regulated by the affiliate (charity 304 or service provider 308) company's overall objectives. The facilitator may customize and integrate its applications so they are presented as privately labeled campaigns to fit with the affiliate's needs.

In some embodiments, the facilitator assists with charitable rebate campaigns, e.g., by providing full end-to-end campaign support and administration to enable a company or other entity 308 to “give back” to the charities and causes that its customers, members, shareholders and employees are passionate about. This may include online private label links 224, application processing 716 or point of sale campaigns 716 all seamlessly embedded within the provider's own infrastructure. The rebates would apply to new or current customers 302, with emphasis on providing rebates when customers purchase new or additional services or products 338 and a “charitable commission” is issued back 328, 334 to the cause 304 of their choice. The campaign may be fully customizable to meet the marketing objectives of the provider 308.

In some embodiments, the facilitator assists with gift certificate rebate programs. For online and offline retailers, the facilitator provides 716 marketing channels 114, 336 for gift cards/certificates so gift card purchases can initiate rebates to each of the causes their customers are passionate about. The program can be simple to implement but nonetheless powerful in creating a strong bond of loyalty every time a customer buys gift cards online or offline.

In some embodiments, the facilitator assists with customer survey campaigns. Instead of “respond and you could win $10,000” campaigns, the facilitator offers 716 a survey that empowers individuals 302 to respond to questionnaires that provide valuable data and in exchange, to donate set-funds to their favorite cause. Whether it's through online URL links 224, 336, direct mail pieces or mailing inserts, shareholder meetings, call center support 228 or any other avenue, the facilitator may provide a solution to fit the affiliate 304, 308 needs.

In some embodiments, the facilitator provides anonymity, in the sense that branding of campaigns 714 is not based on coop or partnership-based marketing but is done instead as a fully implemented program of facilitator clients 304, 308 to their own customers, members, shareholders and employees. The facilitator is the engine behind the scenes that promotes, provides support and administrates entire campaigns for its clients. The facilitator may provide infrastructure 200, 508, 510.

The facilitator can provide robust and seamless validation services of charitable organizations and foundations (agencies) 304 to ensure that agency selections 704 for distribution 334 of charitable funds comply with service provider 308 policies and guidelines, as well as strict adherence to the USA Patriot Act and similar laws and regulations.

The facilitator may also establish and monitor communications between alliance partners, namely service provider businesses 308, charitable organizations 304, and individuals 302. This could include local charitable event support, for example. As a representative of its clients, the facilitator may regularly attend and support local charity events and promotions to ensure broad representation on all local and community levels. This will additionally provide those clients with individual marketing and brand awareness to further increase bonds of trust, loyalty and community awareness. The facilitator may also provide a local, regional, national, or international team of community representatives, some of which may be recruited through the website 120, 200, 222, 224. The facilitator may support each such geographic area with official facilitator representatives that can interact and support local charitable organizations on its client's behalf. This could include local marketing and promotions that are directly associated with charitable organizations to identify special needs or opportunities for the clients to participate and support community events and promotions. The facilitator may also provide 716 opt-in email campaigns 714 to individual members 302. The facilitator may build and manage an email database 508 of supporters to promote new channels of products, give appreciation for support, give charitable organization updates, and use a myriad of other opt-in email campaigns to connect its clients directly with their customers and leverage the charities and causes as the communication vehicle.

The facilitator should provide stringent financial protocols and data security measures to ensure timely and efficient processing of donation disbursement. In some embodiments, facilitator services include: charitable organization validation and disbursement of funds applications; live web reporting portal with auditing features 212, 230, 232; donation tracking applications with full auditing features for each separate client 304, 308; an option for complete trustee account 330 set-up for distribution of funds; a 24 hour online surveillance team and fraud hotline support 228; secured 712 data centers 508 with strict permission and access security protocols; firewall protection 712; current encryption technologies 712 to safeguard digital data; user policies and terms of use policies that clearly protect 712 data whether generated by clients or generated internally by the facilitator.

More About Marketing

The alliance as a whole, and/or individual participants such as the facilitator 310, may center efforts for expansion in service provider industries, and/or the charitable cause industry, for example. In one embodiment, initial marketing 714 plans focus on three types of consumers as potential members 302/314, as listed generally below. Alternate definitions with different individual characteristics are also possible, e.g., by further delimiting, supplementing, omitting, and/or regrouping the characteristics listed below. Initial introduction to the charitable organization 304 and/or service provider 308 may be made through the following individuals to convince the executive teams and influential partners of the benefits of participation in the alliance.

1. Target 714 “Involved & Influential Individuals” (otherwise known as I-3s)
a. Individuals that give money and volunteer time to their cause
b. Passionate about the cause
c. High visibility and status
d. May hold an appointment or elected position within cause
e. Wield large checkbooks and bank accounts
f. Great connections and/or network
g. Willing to use status to exert pressure

2. Target 714 “Involved Individuals” (otherwise known as I-2s)
a. Individuals who give only money
b. Mild interest in cause through associates, friends or family members
c. Would be willing to volunteer if called upon
d. Short-term supporter of the cause

3. Target 714 “Individuals” (otherwise known as I-1s)
a. Individuals who volunteer only their time
b. Tight financial budgets but would do all else to support the cause
c. Willing to give the support required to market new programs and campaigns
d. Committed to cause for a very long time

Once the leadership of an organization is convinced of the benefits of participation in the alliance 300/400, a grass-roots marketing 714 campaign can be initiated to recruit believers and supporters of the program and assist a facilitator with its marketing plans. In some embodiments, costs associated with the marketing and promotion of the alliance are paid by the facilitator. In some circumstances, service providers may assist with co-op advertising funds and assistance, depending on facilitator credibility as a significant marketing tool.

In some embodiments, marketing 714 proceeds in three phases. The first marketing phase will initiate a micro-marketing campaign that will target specifically the I-3s. The main purpose of the marketing campaign will be to introduce 706 the alliance as the new standard in fund-raising and introduce redirected expenditures fundraising (REF). This may require significant travel, and relationship building campaigns across all affiliation platforms. Once I-3s have committed to supporting the alliance, in a second marketing phase marketing materials and collateral will be developed in conjunction with the affiliate's standards for contacting its members to support a large-scale marketing campaign. One approach used to introduce the alliance to members will utilize a permission-based marketing campaign. With support from the facilitator, this campaign will be endorsed and originate from the executive teams of the affiliation 304 to its I-1 membership. The third phase will involve a grass-roots marketing campaign that focuses on promoting and marketing the alliance from the ground-floor up. This will include the training and education of I-2s and I-3s or localized chapters of the affiliation that can fuel excitement among local members to support the alliance; this is reflected in the Become an Area Advocate region referenced at 120 in FIG. 1, for instance. As part of this phase, localized advertising in media outlets may be initiated, along with live seminars and expos for localized support and promotional efforts.

In one embodiment, the following characteristics illustrate target 714 demographics for each marketing phase; other embodiments may use different demographic groupings, characteristics, and/or values:

PHASE 1: I-3 Involved Influential Individuals:

| | |
|---|---|
| Average Annual Income: | $85,000 or above |
| Median Age: | 45-70 Years Old |
| Married Status: | Married/2+ children |
| Gender: | 40% Female-60% Male |
| Affiliate Experience: | 15 years or more |
| Charity Involvement: | Very Active |

PHASE II: I-1 Passionate Individuals:

| | |
|---|---|
| Average Income: | $20,000-$45,000 |
| Median Age: | 20-35 Years |
| Married Status: | Single 60%-Married 40% |
| Gender: | 80% Female-20% Male |
| Affiliate Experience: | 2-10 Years |
| Charity Involvement: | Very Active |

PHASE III: I-2 Involved Individuals:

| | |
|---|---|
| Annual Income: | $45,000-$85,000 |
| Median Age: | 25-45 Years Old |
| Married Status: | Married/2+ children |
| Gender: | 70% Female-30% Male |
| Affiliate Experience: | 5-10 Years |
| Charity Involvement: | Semi-Active |

As noted, a facilitator 310 may focus on becoming the leader in a new fund-raising category known as “Redirected Expenditures Fundraising” (REF). A given facilitator may be viewed as an affiliate marketing company that connects affiliations, members and service providers together to synergize the relationship for the benefit of all. Such a coalition is an alliance, which will market and sell REF and the charitable donation arrangements described herein, as a new option in fund-raising for charitable causes and organizations.

In some embodiments, marketing for the alliance will be specifically targeted 714 at individuals who are already active members of charitable organizations 304, 318 and would be passionate about giving back to support their cause. As such, campaigns can be focused and concentrated on generating a grass-roots support within charitable organizations and providing them with the tools and know-how in marketing redirected expenditure fundraising through the alliance 400 to their faithful supporters. A facilitator may choose to not initiate large brand marketing campaigns that target the general mass population of any region but to instead only introduce 706 the concept in each region and emphasize its ability to unite caring merchants, established charitable organizations and individuals and the need for everyone to make a difference by signing-up for free.

Additional marketing can be generated by facilitator clients 304, 308. An alliance 300, 400 can be aggressively marketed by merchants as an internal campaign rather than a co-branded program. This may be advantageous for reasons such as the following: merchants 308 should receive all the credit associated with giving back to customer causes; the facilitator is only the engine supporting the merchants and administering the program and campaign behind the scenes; if the facilitator is solely left with marketing this opportunity alone, then more of the funds designated to charities would be used-up in related marketing costs; if the facilitator is perceived as more of a service provider or retailer, then organizations and their members will be less likely to participate.

As part of the targeted marketing 714 and/or in other contexts, embodiments of the invention may provide 706 descriptions of the alliance 300, 400, including for instance a description of redirected expenditure fundraising funds flow and the relationship and interaction between members 302, service providers 308, charities 304, and perhaps other entities 31, 306, 314, 318, 320, 322, in a charitable donation arrangement according to the invention. Such descriptions may be given 706 in targeted marketing materials through email, direct mail, and so on, or in more general campaigns. Such descriptions may also be given 706 on the facilitator website 200, in the overview pages 210, for instance, and in areas such as the “our alliance” section 618.

A general marketing plan for a facilitator within each region of expansion may include components such as the following. The facilitator may hire and train eight to twelve (for instance) community representatives per region to represent the facilitator within their communities at local events including fairs and athletic activities, and in cooperation with merchants, businesses, charitable organizations and neighborhoods within a defined geographic area or industry. The facilitator may provide support with promotional items, door hangers and other printed informational materials as well as monthly meetings and training workshops that promote the merchants and their services to support the cause. The facilitator may be a presence at local events. For instance, a ten-by-ten foot or other tradeshow booth may be provided by the facilitator to represent participating merchants and charitable organizations through use of company logos, video presentation, and brochures, as well as active online web signups. Efforts may be made to build recognition of alliance 300, 400 members and merchants by being represented at various civic events such as the Home Show, Garden Show, Boat Show, RV Show, as well as fundraising and promotional events produced by participating charitable organizations such as marathons, festivals, and so on. Advertising may also be done 706 to promote the alliance, on radio, television, and in print media, as well as online.

Web marketing may take in part the form of an account summary page 100. In some embodiments, every member of the alliance is provided with their own personal pages 100 accessible only to that individual, secured 712 by a personal user name and password. On these pages, members are able to view their monthly giving statement, a detailed accounting 212 of merchants 308 who have redirected funds and the charitable causes 304 the members have selected to receive those funds. In addition to building name recognition for these companies and organizations, such pages may provide additional opportunities for marketing. A defined area 224 on each page can be provided for message posting, where merchants and charitable organizations can inform alliance members of upcoming events, discounts, promotions, etc. In addition, merchants can promote 116 their products and services directly to the individual by purchasing banner ads within these individual account summary web pages. The benefit of these particular banner ads is that they can be specifically targeted to select groups within the alliance based on demographic information obtained through the management software 508.

Members may also receive emails recognizing them for their participation in the alliance. Generated by the facilitator management software 508, these emails 716 represent both the merchants whose service 338 they use 804 and the charitable organization 304 that they have chosen to receive redirected funds. These emails can be quasi-random in their distribution based on selected criteria within the management software, so that they are more likely to be highly regarded. Banner ads and web marketing can be utilized by insertion on charity-related websites, local newspaper sites and other targeted areas tailored to each region. Press kits, “get the word out” kits, direct mail, infomercials, testimonials, award dinners, newsletters, and other traditional marketing tools can also be used 706.

More About Funds Flow

Some embodiments provide one or more of the following client donation and funds flow options, under which donations are processed and paid to charities and organizations. Any of these financial flow options can provide a seamless integration into a facilitator client's existing financial infrastructure and create a shell of security and accountability over the treatment of donations and associated funds.

A first option, which may well be the most commonly used, proceeds as follows. The facilitator 310 establishes an escrow or trustee bank account 330 in coordination with the client service provider's internal financial department. The bank account is an extension of the client's own financial accounts but is established strictly for the charitable donation program 300. The account controls stipulate that the facilitator is granted a limited right of attorney to distribute and manage the account based on its specific administrative duties. Funds designated as a rebate or commission would be directed to this trustee account from the client. The facilitator would then distribute 334 the funds to charitable organizations 304 as a donation on behalf of the client 308. Administration of the account would include managing the accounting details, reconciliation duties, distribution of donations, auditing and reporting duties, etc. Payment 814 for the facilitator 310 administration services would be made as a separate administration fee which would equal 20% (for instance) of funds deposited into trustee bank account. Payment to the facilitator could be made 814 from the trustee account or invoiced as a separate fee, depending on the client's preference.

Under a second option, the facilitator (if non-profit) or an alliance non-profit foundation establishes an escrow or trustee bank account 330 in which the client 308 is granted a limited right of attorney over funds in case of default in properly distributing 334 those funds to charitable organizations 304. In addition, distribution of funds would be limited to specific administrative duties and could be regularly audited by the client 308 at their sole discretion. Funds designated as a rebate or commission would be donated 328 by the client to the trustee account as a charitable donation. The facilitator would then distribute 334 the funds to charitable organizations as a donation on behalf of the client. Administration of the account 330 would include managing the accounting details, reconciliation duties, distribution of donations, auditing and reporting duties, etc. Payment for facilitator services would be made as a separate administration fee which would equal 20% (for example) of funds deposited into the trustee bank account. Payment could be made 814 from the trustee account or invoiced as a separate fee depending on the client's preference.

Under a third option, the facilitator (which may be a for-profit entity) establishes an escrow or trustee bank account 330 in which the client 308 is granted a limited right of attorney over funds in case of default by the facilitator in properly distributing those funds to charitable organizations 304. In addition, distribution of funds would be limited to specific administrative duties and could be regularly audited 328 by the client at their sole discretion. The facilitator receives 814 payment from the client as a straight commission or rebate for each sale, e.g., under an affiliate or agent agreement. The funds are then distributed 334 and processed by the facilitator to charitable organizations 304 as a donation from the facilitator. Administration of the account includes managing the accounting details, reconciliation duties, distribution of donations, auditing and reporting duties, etc. If the payment is classified as taxable income to facilitator (as it apparently would be, at least under US law), the service fee would be increased to 45% (for instance) to cover tax liability, with the remaining 55% (in this example) being distributed to charitable organizations. Since a given facilitator may desire to send 334 as much of the rebate or commissions onto the charitable organizations as possible, this option may not be as favorable as the other options discussed above.

Regarding all fund flow options, this is a patent document, not a tax opinion or legal ruling. Facilitators 310, charities 304, members 302, service providers 308, and other organizations and individuals should not rely on any statement made herein as being authoritative or binding as to tax or corporate law, in the United States and/or in other jurisdictions. Competent local tax and corporate counsel and other specialized advisors should instead be consulted as needed to determine what entity form, and what funds flow, is appropriate in particular circumstances.

Additional Examples

One embodiment includes an interactive member portal 100 accessible by an alliance member 302 to manage a charitable donation arrangement through a computer network 506 such as the internet or a LAN, WAN, or other packet-switched, wireless, VPN, label-switched, telephone, or other network. The member portal includes an accounting 212 showing at least one donation amount 216, 218; an interface 202 for selecting at least one service provider 308 from multiple service providers identified in the portal 100; an identification of at least one selected service provider; an interface 204 for selecting at least one charity 304 from multiple charities identified in the portal 100; and an identification of at least one selected charity. The at least one donation amount shows at least one amount which is redirected to the at least one charity from each of a sequence of payments 326 of a recurring bill for at least one service 338 which the at least one service provider provides 804 to the alliance member. “Recurring” means monthly, or weekly, or every other month, or every third week, etc., or even at unevenly spaced but multiple instances, such as whenever the provider sends 806 a bill. There need not be a one-to-one correspondence between the total set of recurring payments in a given period and fund redirection events in that period. The interactive member portal 100 can be stand-alone or it can be located within a website 200 of a facilitator 310. The facilitator may provide a service 338 in some embodiments, but is not among the multiple identified service providers in other embodiments.

The accounting 212 shows a non-aggregated donation amount, namely, a donation for the particular alliance member 302 in question. Some accountings 212 show, on a per-provider and/or per-charity basis, for the member 302, a total payment 214, namely, the alliance member's recurring bill amount for a selected service provider. Some show an undistributed amount 216, namely, a portion of the total payment that has not yet been designated for redirection to any of the charities. Some show a distributed donation amount 218, namely, a portion of the total payment that has been designated by the alliance member for redirection to at least one selected charity. Some show other figures which are equivalent in the sense that these can be derived from them arithmetically. Some embodiments include an aggregate funds amount 502, namely, an amount of total funds redirected by a group of people (e.g., affiliate 306 members) that includes the alliance member 302.

Multiple charities and/or multiple service providers may be selected by a member 302. For instance, in some situations at least three charities are selected, and the accounting 212 shows respective redirected fund donation amounts for each of the at least three charities from payment of at least one recurring bill of at least one selected service provider. In some situations at least two service providers are selected, and the accounting 212 shows respective redirected fund donation amounts for at least one selected charity from payments of respective recurring bills of the at least two selected service providers.

In some embodiments, the interactive member portal 100 includes one or more of the following: an update 224 directed to at least the alliance member from a selected charity, namely, charity-specific information from a charity selected by the alliance member to receive redirected funds donations; a new charity field 226 for receiving 316 from the alliance member an identification of a charity 318 for possible addition to the multiple identified charities; an invitation interface 226 for receiving 314 from the alliance member an email address of a candidate member 314 and sending the candidate member an invitation from the alliance member to become another alliance member; a new provider field 226 for receiving 316 from the alliance member an identification of a service provider 320 for possible addition to the multiple identified service providers; a shopping portal 220 for alliance member access to online shopping locations 322 which make donations to the at least one selected charity in response to purchases made by the alliance member.

Some embodiments include a method of interactive control of a charitable donation arrangement through a computer network 506. Control may be effected from a facilitator 310 perspective, or from a member 302 perspective, provider 308 perspective, or another perspective, but for conciseness only the facilitator perspective is detailed here. However, corresponding steps and/or methods performed by a member, provider, or other entity may also fall within the scope of the present invention.

More generally, a close reading of this document will show that, to provide a concise but thorough description of the invention, the same reference number has been used herein for a step performed by one entity as for a corresponding step performed by another entity. Thus, reference 804 refers both to providing services (provider 308 perspective) and to receiving services (member 302 perspective). Likewise, reference 814 refers both to paying the facilitator (provider 308 perspective) for administrative and/or marketing assistance and to being paid for providing such assistance (facilitator 310 perspective). Similarly, for conciseness devices and uses of the devices are sometimesboth referenced herein with the same number, even though many steps can also be performed with devices other than the specific devices described herein. For example, 202 refers both to a service provider selection interface (device) and to selection of a service provider (use of device, whether it be a specific device discussed herein or some other device).

From a facilitator 310 perspective, then, some embodiments include providing 702 over the network a programmed (meaning software, hardware, or both) interface 202 for selecting at least one service provider 308 from multiple identified service providers, and providing 704 over the network a programmed interface 204 for selecting at least one charity 304 from multiple identified charities. Step 702 may identify service providers from at least the following categories: internet access service providers, wireless network service providers, telephone service providers, voice over IP service providers, television programming service providers, utility service providers. Step 702 may also provide over the network an interface for subscribing to a service provider as a new customer under the charitable donation arrangement. Step 704 may provide an interface 204 which allows the alliance member to change a current charity selection by selecting, prior to a cutoff date for an upcoming billing cycle, at least one different charity which is to receive redirected funds from payment of the recurring bill for that upcoming billing cycle.

Some embodiments include providing 706 over the network a description of the charitable donation arrangement 400 which indicates that under the arrangement a donation amount will be redirected to at least one charity selected by an alliance member from each of a sequence of payments of a recurring bill sent to the alliance member from at least one service provider selected by the alliance member. The sequence need not be consecutive payments. In some cases the description indicates that redirected fund donations are not tax-deductible by the alliance member 302. Each of the providing steps occurs at least at an alliance member location, namely, a location which presents the programmed interfaces to the alliance member. Thus, placing the servers 508 that bear the facilitator website 200 and/or the member portal 100 server-side software beyond the boundary of a given country will not prevent infringement of a claim within that country if the member 302 receives the interfaces 202 and/or 204 inside that country. Some embodiments include requesting 712 a password from the alliance member 302 and then providing 708 over the network 506 to the alliance member in response to entry of a correct password an accounting 212 and/or other secured 712 information under the charitable donation arrangement.

In some but not all embodiments, services 338 are provided under the charitable donation arrangement 400 at the same price as under other arrangements in which no portion of the service fee 326 is redirected to a charity. Thus, the step 706 of providing over the network a description of the charitable donation arrangement may provide a description indicating that the alliance member can redirect a portion of payments of the recurring bill from a selected service provider to a selected charity without spending additional money.

Some embodiments include targeting 714 at least one of the following defined groups: involved and influential individuals, involved individuals, passionate individuals, influential individuals. In some, the targeting includes use of advertising that identifies a website 200 through which the interface providing steps 702, 704 occur.

In some embodiments, a method can be used by a service provider 308 to promote customer loyalty by providing a service in a charitable donation arrangement. The method includes agreeing 802 to be one of multiple service providers that are identified to an alliance member 302 as service providers who will donate to at least one charity 304 a portion of each of a sequence of payments of a recurring bill for a service to be provided to the alliance member as a customer of the service provider. The sequence need not be monthly, and need not be consecutive—one might donate from every other payment, for instance. This method also includes providing 804 the service to the alliance member; billing 806 the alliance member on a recurring basis for payment for the service; receiving 808 payment for the service; authorizing 810 payment on a recurring basis of a donation amount to the at least one charity as agreed; and providing 812 an accounting 212 or portion thereof, for the individual alliance member as a customer. Authorizing 810 payment may include directing a portion of the payment from the alliance member into a trustee bank account 330 from which a facilitator 310 has a right to distribute funds to the at least one charity selected by the alliance member.

Some embodiments include a facilitator method having steps of agreeing 802 with a charity that the charity may be publicly identified in a promotion 706 as a beneficiary of funds that will be initially directed to a service provider rather than to the charity; agreeing 802 with the service provider that the service provider will redirect to the charity a specified portion of funds received from members of an affiliate 306; and agreeing 802 with the affiliate that the affiliate will promote to its members an arrangement under which the member pays funds to the service provider and receives value in return but does so in the expectation that a portion of the funds from the member will be redirected by the service provider to the charity.

Some embodiments include a method for producing a distribution of funds, including providing at least one server computer 508 in communication with a computer network 506; providing 702 input to the server specifying a service provider; providing input 206 to the server specifying a member; processing data by the server to associate the member with the service provider through a subscription agreement; providing 202, 204 input to the server specifying a portion of funds to be redirected from the service provider to an affiliate 306; and generating output 212 from the server confirming the redirection of funds.

Some embodiments include apparatus, including at least one server computer 508 having an interface for communicating over a computer network 506; and a database managed using the server computer and associating members 302, affiliates 304, and service providers 308, wherein the database specifies a redirection of funds from service provider subscription fees to affiliates as directed 702, 704 by members.

Some embodiments include a computer-readable memory 504, 508, 510 for storing data for access by an application program 100 being executed on a data processing system, including a value representing a member 302; a value representing a service provider 308; a value representing an affiliate 304; a value 214 representing a total amount paid by the member; a value representing a portion of the total amount retained by the service provider (value 214 minus the donation); and a value representing a portion of the total amount redirected 218 to the affiliate.

Some embodiments include a memory in a device 504, 508 configured by a data component and an instruction component. The data component includes a list of demographically selected involved influential individuals 314 and passionate individuals 314. The code component includes a multimedia presentation which, when presented 706, promotes redirected expenditures fundraising.

Some embodiments include an article of manufacture including a computer usable medium 510 (DVD, CD, flash memory, hard disk, RAM, or the like) having computer readable code embodied therein. The code has a data component and an instruction component. The data component includes a list of demographically selected involved influential individuals 314 and passionate individuals 314. The code component includes a multimedia presentation which promotes 706 redirected expenditures fundraising.

Some embodiments (in jurisdictions recognizing them) include a computer program product for use with a computer 504, 508, the computer program product including a computer usable medium 510 having computer readable code embodied therein, the code having a data component and an instruction component, the data component including a list of demographically selected 714 involved influential individuals 314 and passionate individuals 314, the code component including a multimedia presentation which promotes 706 redirected expenditures fundraising. Likewise, some embodiments include a computer data signal embodied in a carrier wave, including a value representing a member 302, a value representing a service provider 308, a value representing an affiliate 304, a value representing a total amount 214 paid by the member, a value representing a portion of the total amount retained by the service provider, and a value representing a portion of the total amount 218 redirected to the affiliate.

Some embodiments include a system for redirecting funds from service provider payment to charitable cause donation, including a server computer 508 accessible via a computer network 506 to at least one client computer 504; a web portal 200 hosted on the server computer, the portal for redirected expenditure fundraising; wherein the server hosts a user interface 100 of the web portal which accepts 712 user identification and authentication values, displays 704 at least one affiliate identifier, displays 702 at least one service provider identifier, accepts user selection of an affiliate, accepts user selection of a service provider, and displays 708 at least a default redirection of funds from the service provider to the affiliate in response to a user indication of approval to redirect funds. In some embodiments, a user interface 108 also accepts specific percentages of redirection funds 216 to be allocated to each of at least two identified affiliates in response to a user indication of approval to redirect funds.

Some embodiments include a method for facilitating charitable contributions, including providing a web site 200 hosted by at least one computer 508 in communication with a computer network 506, performing steps 206 to obtain data for demographically categorizing individuals as involved and influential, as passionate, or as involved, according to previously established demographic criteria, and performing such categorization using obtained data.

Some embodiments include a member 302 method for contributing to an affiliate 304, including accessing 716 at least one client computer 504 which communicates with a computer network 506; specifying 702, 704 through the client that a portion of a service provider payment be redirected to an affiliate, the affiliate being a charitable entity; and viewing 708 on a display of the client financial values which reflect a resulting distribution of funds between at least the service provider and the affiliate. In some but not all embodiments, the affiliate is identified on the client's display as an entity qualified to receive tax-deductible donations. In some, a facilitator service fee amount is also shown on the client's display.

Some embodiments include a system for performing redirected expenditures fundraising, including a client computer 504 running a web browser application program and having access to at least one server computer via a computer network; the client browser providing a user interface having at least three of the following sections: a section 210 introducing 706 a facilitator alliance, a section 616 of uplifting anecdotes, a section 228 providing access to customer support, a section 614 introducing alliance participants, a section 612 identifying service providers and subscription plans; whereby a user interacts 716 with the browser to perform at least one of the following operations: login, read section content, subscribe to a service provider plan, view totals for funds previously redirected by the user, redirect funds from a pool to one or more charities identified by the user through the user interface.

Example FAQ

The following sample FAQ (Frequently Asked Questions and corresponding answers) is based on the NetFundz facilitator website 200, but has been reformatted and supplemented with drawing reference numbers for use in the present document.

What exactly is the Alliance? The Alliance 300, 400 enables individuals 302 to regularly donate additional funds to favorite causes and charities 304 without spending additional money. NetFundz Alliance does not sell goods or services, but manages a partnership between caring individuals 302, charitable organizations 304 and generous corporations 308. Through a patent-pending, easy-to-use Web-based system, members can specify 704 the charitable organizations of their choice for receiving redirected funds from their monthly service bills and select online purchases. This results in sizable monthly donations for designated charitable organizations.

Why was the Alliance formed? First, charities and non-profit organizations need funds to operate and reach their goals. Fundraising is a difficult process that requires great amounts of time and effort. The Alliance provides an alternative to supplement traditional fundraising efforts. Second, service providers want to be good corporate citizens and make charitable contributions to worthy causes. However, they often don't know which organizations to support and don't want to risk omitting any one particular cause. As members of the Alliance, service providers forward 810 NetFundz an amount each month on behalf of all of the members who have subscribed to their services. The NetFundz Alliance then sends 334 those funds directly to each of the causes as designated by you 302, on your behalf. Service providers and other merchants who participate in the Alliance rely on NetFundz to assure they are in compliance with IRS and US Patriot Act regulations for charitable donations. Third, customers not only witness 708 the charitable contributions of merchants and service providers they have chosen, but they are empowered to choose 704 which causes they want to support. Giving the choice to the customers enables the customer to have a voice in that company's philanthropic decisions, resulting in a better relationship.

Can you give me an example of how this can help my cause/organization 304? Imagine just one member 302 of the Alliance designating $2 per month from just one bill to benefit your cause. Now imagine 1,000 members doing the same. That's an extra $2,000 per month flowing 334 to your cause—$24,000 added to your annual budget! And that doesn't even take into account funds generated when members make online purchases!

How does my donation get to my designated cause/organization 304? Each month, participating service providers 308 and merchants 308 forward the NetFundz Alliance funds on behalf of all of the members who have subscribed to their services. The NetFundz Alliance sends 334 the designated 810 amounts directly to each of the causes as designated 702, 704 by the member on their behalf. Member allotments 218 are recorded on a monthly basis (changes can be made no later the 15th of the month). Actual payment 334 of those allotments is dependent on the accounting procedures of each charitable organization.

What percentage of the donation goes to my cause/organization? We make sure that 100 percent goes to your cause. Through the Alliance the set amount from your monthly bill is forwarded to the cause of your choice, at no extra cost to you. For instance, if your DSL Internet access 612 bill is $40, $2.00 from that bill will be contributed to the cause of your choice. The same holds true for online purchases you make through the Alliance shopping portal 220. Different vendors 322 have agreed to donate various percentages of your online purchases. That amount is calculated and deposited 216 into your account. Those funds will be disbursed to the cause of your choice as you have directed 218.

Does the Alliance method replace traditional fundraising methods? This is not the intent of the Alliance. Instead, this alternative method is meant to supplement traditional fundraising efforts. Benefits to this method include its ability to provide a consistent, residual donation that can be large or small, depending upon the number of members and friends who join the Alliance and designate that cause/organization as the benefactor of their redirected funds.

How do I designate 704 what organization I want my monthly donation to go toward? When you join the Alliance, you will be asked to designate the organization you choose to redirect funds to. You can search 204 for it alphabetically or by typing 204 in the name and clicking 204 on the search button.

If my cause/organization 318 isn't on the list, how can I have it added? If you don't see your organization listed, there is a field 226 to insert 316 the organization's name. You'll need to have the name and a contact phone number for it to be verified as eligible for donations. Once it has been approved, it will be published 704 on the list so others can select it as well. Or call 866-916-FUND (8363) and a customer service representative will assist you.

What kinds of causes/organizations 304 can I donate to? Non-profits, charities, school funds (PTA, tuition savings, etc.), foundations, clubs, cultural organizations—any organizations that collect money and other voluntary contributions to perform a service which benefits others. These can be local or national organizations 304. Current members include such organizations 304 as the Utah PTA, the Huntsman Cancer Institute, the Utah Arts Festival to name a few. The Alliance is growing rapidly with charitable organizations joining regularly.

Can I donate to more than one cause/organization? Yes, you can designate 204 as many causes as you'd like with the minimum donation being $1 per month. Simply login 604, which will take you to the “My Accounts” page 108. Here you can view 716 your Giving Statement, which updates your available balance 216 and displays the causes you have designated to receive redirected funds 218. You have the option 204 of setting up the contribution to be an on-going monthly donation or select other causes you wish to support. You have complete control over where and how much is donated. Any changes to your assigned contributions need to be submitted 204 by the 15th of the month in order to take affect during that billing cycle.

As a cause/organization 304, 306, how do I tell our members and friends to support our cause by joining the Alliance? We don't intend to intrude on the information you've collected within your organization. Instead we provide you with the necessary tools to market 706, 714 the Alliance at no charge. You will receive a “Get the Word Out” kit which contains a CD with newsletter templates, both electronic and snail mail; 3 letter templates, including an introduction letter, a follow-up letter and progress letter; 100 flyers; an instruction sheet and 100 registration cards. If you would like a kit, please contact marketing at netfundz dot com or call 866-916-FUND (3863) and speak to a customer representative.

What service providers/merchants 308 are currently participating in the Alliance? We currently offer 702 NetFundz Alliance Dial-up, Qwest DSL, Speakeasy DSL, Telzo Voice Over Internet Protocol (VoIP) and Verizon Wireless. Our shopping portal 220 includes Hallmark, WalMart, Target, JC Penney, Macy's, Ebay, Apple, Enterprise Rent-A-Car, Netflix, Sears, Bath and Body and many more. The Alliance is gaining momentum with new companies joining 802 on a regular basis.

Can I sign up for more than one Alliance service? Absolutely! The more Alliance services you subscribe to, the more money your organization will be able to receive. Depending on the services, the amount donated to your cause can range from $2 to $8 per month.

What if I already subscribe to one of the services 612 the Alliance offers? One of the purposes of the NetFundz Alliance is to help service providers reach new and loyal customers, although several providers welcome existing customers. If your current service provider is an Alliance member, depending on the provider, we can work with them to set up your existing account for redirection of funds from your monthly bill to the cause of your choice. Please call a customer service representative at 866-916-FUND (8363) for help with this process.

What if the Alliance doesn't currently offer services I am interested in? You can join the Alliance without signing up for services, and we will notify you whenever we add new services providers. If you have suggestions for new service providers you would like us to invite to join the Alliance, please email 226 marketing at netfundz dot com

When will other providers and merchants be included? New merchants and service providers are being approached and continue to join 802 the Alliance on a regular basis. Make sure you sign-up for regular newsletters so you can be notified 716 about new merchants and service providers.

How will I be billed for the services? Monthly bills will be sent 806 from the service provider 308 with no significant changes.

How do I tell friends about the Alliance? As a member you'll have access to your own page 100 so that you can review your giving statement 108, 212, get messages 224 from the charities you support and manage 702, 704 the redirection of funds. On this page, we have provided a space 120 where you can share 222 email addresses of members and friends who you think would be interested in joining the Alliance. We will contact them via email to tell 706, 714 them more. Or simply tell your friends to go to www dot netfundz dot com and click on “Join the Alliance” or call 866-916-FUND (3863) to speak with a customer representative.

How do I join the Alliance? It's quite simple and takes just a couple of minutes. Go to www dot netfundz dot com and click 716 on the button “Join the Alliance.” You will be asked 716 to enter your contact information 206, select 702 the services you are interested in and choose 704 the charitable organization you want your funds redirected to. You can also call 866-916-FUND (3863) and have a friendly customer service representative assist you.

Can I join the Alliance without ordering services? Yes. If your service provider is not currently participating you can still become a member and redirect funds when you use the NetFundz Alliance shopping portal 220. Each time you make an online purchase with such companies 322 as Hallmark, Ebay, Delta Airlines, Netflix, Bath and Body, JC Penney, WalMart, Target and many more, you can redirect a percentage of your purchase price to your favorite cause. When you join, you will also receive 716 email newsletters from the Alliance informing you of upcoming charitable events, unique offers from our participating service providers and information on new companies as they join the Alliance.

Does it cost to redirect funds or switch services? No. There is no charge 806 other than the normal cost 326 of the service 338.

Will the service change? Support? Price? No. The service, service provider, customer support and price will remain the same.

Will my email address change? Only if you sign-up for Alliance dial-up services otherwise your email address will stay exactly the same.

Why don't utilities participate? Utility companies do not currently participate with the Alliance but we will continue to garner their support on your behalf.

What if I have technical problems? Call 866-916-FUND (8363) and our technical support 228 staff will be able to handle your questions and concerns. If necessary, we can put you in touch with the service provider for further assistance.

How is NetFundz Alliance compensated? For helping reach new customers, keep current customers loyal and for managing the charitable contributions process of our generous corporate members, NetFundz Alliance is paid 814 a separate marketing fee as fair compensation.

Is NetFundz Alliance regularly audited? Yes. Payments made from the NetFundz Alliance to the respective causes will be audited quarterly based on generally accepted accounting principles.

Are the donations tax deductible? In most cases the donation is not tax deductible for individual members 302, as it was donated to your designated cause/organization by the service provider 308. Please check with your tax advisor. NetFundz Alliance offers you detailed donation reports 212 that can be found within the member's portal 100. How do I get a year-end donation report for tax purposes? Members can simply go to the “My Accounts” page and print a copy of their Giving Statement 212, which is a detailed report of what has been donated to date. In most cases the donation is not tax deductible for individual members, as it was donated to your designated cause/organization by the service provider. Please check with your tax advisor.

Conclusion

In addition to illustrating methods, the flowcharts also help illustrate device 504, 508 and system 300, 400, FIG. 5 embodiments, which those of skill will understand include digital devices and systems configured with processors, other hardware, and software to operate according to the illustrated methods, or variations thereof. Likewise, computer-readable storage media 510 such as hard drives, flash memory, RAM, CDs, DVDs, removable disks, and so on, can be configured with data and/or instructions to perform the illustrated methods, and variations thereof. Variations may repeat steps, omit them, add to them, group them differently, perform them in different orders, and/or otherwise differ from the specific examples illustrated herein, provided they are still operable and conform with the claims. Indeed, reference may be made to other figures while discussing a particular figure, consistent with the fact that the figures help illustrate a variety of embodiments. Some figures include diagrams illustrating devices and systems, users and other people or businesses, and various interactions, in a configuration employing the present invention. Not every illustrated component need be present in every embodiment.

The invention may be embodied in various ways, e.g., processes on a server computer 508, processes on a client or peer computer 504, software (data instructions) in RAM or permanent storage 510 for performing a process, a computer 504, 508 configured by software, data produced by a method, and so on. Computers 504, personal digital assistants 504, cell phones 504, and any other device 504 having user interface and network 506 transmission capabilities may be assisted by a suitable embodiment to operate as described herein.

Although particular embodiments of the present invention are expressly illustrated and described herein as methods, for instance, it will be appreciated that discussion of one type of embodiment also generally extends to other embodiment types. For instance, the descriptions of methods also help describe devices, configured media, and method products. It does not follow that limitations from one embodiment are necessarily read into another.

All claims as filed are part of the specification and thus help describe the invention, and repeated claim language may be inserted outside the claims as needed without violating the prohibition against new matter. Terms such as “a” and “the” are inclusive of one or more of the indicated item or step. In the claims a reference to an item means at least one such item is present and a reference to a step means at least one instance of the step is performed, in the absence of a clear indication that the item or step is optional, in which case it may be present/performed. Headings herein are provided for convenience only; information on a given topic may often be found outside the section whose heading indicates that topic.

Embodiments such as the methods illustrated or corresponding systems may omit items/steps, repeat items/steps, group them differently, supplement them with familiar items/steps, or otherwise comprise variations on the given examples. Suitable software to assist in implementing the invention is readily provided by those of skill in the pertinent art(s) using the teachings presented here and programming languages and tools such as C++, C, Java, scripting languages, HTML, XML, APIs, SDKs, network protocol stacks, assembly language, firmware, microcode, compilers, debuggers, and/or other languages and tools.

Although this document includes website addresses, the addresses and the material on the sites addressed by the stated addresses are provided only for background and/or as examples to help illustrate the invention. The document does not incorporate by reference any essential material from those websites or other sources.

The embodiments discussed are illustrative of the application for the principles of the present invention. Numerous modifications and alternative embodiments can be devised without departing from the spirit and scope of the present invention.

We claim:

1. An interactive member portal accessible by an alliance member to manage a charitable donation arrangement through a computer network, the member portal comprising:
an accounting showing at least one donation amount;
an interface for selecting at least one service provider from multiple identified service providers;
an identification of at least one selected service provider;
an interface for selecting at least one charity from multiple identified charities;
an identification of at least one selected charity;
wherein the at least one donation amount shows at least one amount which is redirected to the at least one charity from each of a sequence of payments of a recurring bill for at least one service which the at least one service provider provides to the alliance member.

2. The interactive member portal of claim 1, wherein the member portal is located within a website of a facilitator and the facilitator is not among the multiple identified service providers.

3. The interactive member portal of claim 1, wherein the accounting shows a non-aggregated donation amount, namely, a donation for the particular alliance member in question.

4. The interactive member portal of claim 1, wherein the accounting shows:
a total payment, namely, the alliance member's recurring bill amount for a selected service provider;
an undistributed amount, namely, a portion of the total payment that has not yet been designated for redirection to any of the charities; and
a distributed donation amount, namely, a portion of the total payment that has been designated by the alliance member for redirection to at least one selected charity.

5. The interactive member portal of claim 1, wherein at least three charities are selected, and the accounting shows respective redirected fund donation amounts for each of the at least three charities from payment of at least one recurring bill of at least one selected service provider.

6. The interactive member portal of claim 1, wherein at least two service providers are selected, and the accounting shows respective redirected fund donation amounts for at least one selected charity from payments of respective recurring bills of the at least two selected service providers.

7. The interactive member portal of claim 1, further comprising at least one of the following:
an update directed to at least the alliance member from a selected charity, namely, charity-specific information from a charity selected by the alliance member to receive redirected funds donations;
a new charity field for receiving from the alliance member an identification of a charity for possible addition to the multiple identified charities;
a new provider field for receiving from the alliance member an identification of a service provider for possible addition to the multiple identified service providers;
an invitation interface for receiving from the alliance member an email address of a candidate member and sending the candidate member an invitation from the alliance member to become another alliance member;
a shopping portal for alliance member access to online shopping locations which make donations to the at least one selected charity in response to purchases made by the alliance member.

8. A method of interactive control of a charitable donation arrangement through a computer network, the method comprising:
providing over the network an interface for selecting at least one service provider from multiple identified service providers;
providing over the network an interface for selecting at least one charity from multiple identified charities;
providing over the network a description of the charitable donation arrangement which indicates that under the arrangement a donation amount will be redirected to at least one charity selected by an alliance member from each of a sequence of payments of a recurring bill sent to the alliance member from at least one service provider selected by the alliance member;
each of the providing steps occurring at least at an alliance member location, namely, a location which presents the interfaces to the alliance member.

9. The control method of claim 8, further comprising providing over the network an accounting which shows:
a total payment, namely, the alliance member's recurring bill amount for a selected service provider;
an undistributed amount, namely, a portion of the total payment that has not yet been designated for redirection to any of the charities;
a distributed donation amount, namely, a portion of the total payment that has been designated by the alliance member for redirection to at least one selected charity; and
an aggregate funds amount, namely, an amount of total funds redirected by a group of people that includes the alliance member.

10. The control method of claim 9, wherein the aggregate funds amount shows total funds redirected by people in an affiliate organization which is identified to the alliance member over the network by the method.

11. The control method of claim 8, further comprising requesting a password from the alliance member and then providing over the network to the alliance member in response to entry of a correct password an accounting which shows a donation amount for the alliance member under the charitable donation arrangement.

12. The control method of claim 8, wherein the step of providing over the network a description of the charitable donation arrangement provides a description indicating that the alliance member can redirect a portion of payments of the recurring bill from a selected service provider to a selected charity without spending additional money.

13. The control method of claim 8, further comprising targeting at least one of the following defined groups: involved and influential individuals, involved individuals, passionate individuals, influential individuals; and wherein the targeting includes use of advertising that identifies a website through which the interface providing steps occur.

14. The control method of claim 8, wherein the step of providing over the network a description of the charitable donation arrangement provides a description indicating that redirected fund donations are not tax-deductible by the alliance member.

15. The control method of claim 8, wherein the step of providing over the network an interface for selecting a service provider identifies service providers from at least two of the following categories: internet access service providers, wireless network service providers, telephone service providers, voice over IP service providers, television programming service providers, utility service providers.

16. The control method of claim 8, wherein the step of providing over the network an interface for selecting at least one charity allows the alliance member to change a current charity selection by selecting, prior to a cutoff date for an upcoming billing cycle, at least one different charity which is to receive redirected funds from payment of the recurring bill for that upcoming billing cycle.

17. The control method of claim 8, further comprising providing over the network an interface for subscribing to a service provider under the charitable donation arrangement.

18. A method for use by a service provider to promote customer loyalty by providing a service in a charitable donation arrangement, the method comprising:
agreeing to be one of multiple service providers that are identified to an alliance member as service providers who will donate to at least one charity a portion of each of a sequence of payments of a recurring bill for a service to be provided to the alliance member as a customer of the service provider;
providing the service to the alliance member;
billing the alliance member on a recurring basis for payment for the service;
authorizing payment on a recurring basis of a donation amount to the at least one charity as agreed; and
providing an accounting showing at least the donation amount per billing cycle and a total donation amount made up to a specified date, for the individual alliance member as a customer.

19. The service provider method of claim 18, wherein authorizing payment includes directing a portion of the payment from the alliance member into a trustee bank account from which a facilitator has a right to distribute funds to the at least one charity selected by the alliance member.

20. The service provider method of claim 18, further comprising paying an alliance facilitator an administration fee in exchange for assistance in administering the charitable donation arrangement.
